(19) United States
(12) Patent Application Publication
(10) Pub. No.: US 2002/0071421 A1
(43) Pub. Date: Jun. 13, 2002

(54) Method and system for data loss detection and recovery in wireless communication process

(75) Inventors: Yen-Chang Chiu, Taipei (TW); Chin-Nan Wu, Tainan (TW); Chia-Shan Wei, Junghe City (TW); Ki-Dar Lin, Taichung (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Elan Microelectronics Corporation

(21) Appl. No.: 10/021,726

(22) Filed: Dec. 12, 2001

(30) Foreign Application Priority Data
Dec. 12, 2000 (TW) 89126503

(51) Int. Cl. H04J 3/24

(52) U.S. Cl. 370/349; 370/394

(57) ABSTRACT

A remedy for data loss generated during a wireless communication process is to incorporate a data sequence identification field into a data frame to be transmitted from a wireless transmitting end to a wireless receiving end. The data sequence identification field contains a first data value representing a sequence number of the data frame, and the wireless receiving end records a second data value representing the sequence number of the data frame next to the last data frame the wireless receiving end has received. The wireless receiving end compares the first data value with the second value to determine whether the received data frame is a succession of the last data frame the wireless receiving end has received, so as to remind the user of the lost data frame by generating alarm signal or send retransmission request signal to request the wireless transmitting end to retransmit the lost data frame.

### FIELD OF THE INVENTION

The present invention is generally related to a data transmission technique in a wireless communication process, and more particularly, the present invention is related to a remedy for data loss which comes about during the wireless communication process.

### BACKGROUND OF THE INVENTION

For the current consumptive electronic products, the layout of taking wireless input device as a fundamental user input interface has been gradually come into vogue with the development of wireless communication technique. Most of the wireless input apparatus today makes use of radio frequency signals or infrared signals to communicate with a wireless signal receiving apparatus connected to a host (for example, a personal computer). Because the wireless input apparatus takes wireless signals in place of traditional communication cables as the media for carrying out data transmission, it is provided with the advantages of great portability and high data transmission rate.

FIG. 1(a) is a systematic block diagram showing a unidirectional wireless communication system. In the unidirectional wireless communication system of FIG. 1(a), the wireless input apparatus 11 includes an input interface 111 for prompting the user to enter data thereof. When the user has entered data through the input interface 111, a corresponding data signal will be triggered. The data signal will first be saved into the input buffer 112 (which is materialized by a first-in first-out (FIFO) buffer), and then converted by the microprocessor 113 into scan codes. The embedded encoder of the microprocessor 113 (not shown) encodes these scan codes into an encoded data packet for transmission by a wireless signal in a data frame format. When the data encoding process is finished, the wireless signals such as radio frequency signals or infrared signals carrying the data frame will be transmitted by the wireless communication transmitting module 114 onto the channel 14. The transmitted data frame will be recorded by a memory 115 of the wireless input apparatus 11, for example, a FIFO memory.

After the wireless signal carrying the data frame has been transmitted onto the channel 14, it will be received by the wireless communication receiving module 121 of a wireless signal receiving apparatus 12. The micorcontroller 122 of the wireless signal receiving apparatus 12 will perform data decoding process based on the associated software routines stored therein to decode the encoded data packet within the data frame into original data signals. When the decoding procedure is finished, the original data signals will be transmitted to a host 13 such as a personal computer through a communication cable 15. The host 13 will proceed with associated operations according to the data signals transmitted from the wireless signal receiving apparatus 12.

However, if an error within the data packet is detected in the middle of the data reception and decoding processes, the microcontroller 122 will drive the alarm signal generator 125 such as a buzzer to generate alarm signals for reminding the user of the data error problem.

FIG. 1(b) is a systematic block diagram showing a bi-directional wireless communication system. The bi-directional wireless communication system of FIG. 2 is similar to the unidirectional wireless communication system of FIG. 1. However, because the wireless communication system of FIG. 2 utilizes bi-directional wireless communication technique to proceed to the data transmission/reception process, a wireless communication receiving module 116 and a wireless communication transmitting module 123 are respectively located in the wireless input apparatus 11 and the wireless signal receiving apparatus 12. When an error is detected during the data reception or decoding process, the microcontroller 122 of the wireless signal receiving apparatus 12 generates an error signal containing corresponding error message indicative of the error code and error type for transmission to the wireless input apparatus 11 by the wireless communication transmitting module 123. After the wireless communication receiving module 116 receives the error signal, the microcontroller 113 of the wireless communication apparatus 11 will deal with the error message based on the content recited therein.

FIG. 2 schematically shows the data frame format for use in the conventional wireless communication system. The data frame as shown in FIG. 2 comprises a preamble 21, a start bit 22, a device ID field 24 and one or more data packets 25. At the end of the data packet, an error detection code containing data values based on the data values within the data packet is appended to the data packet, which is used to be analyzed to detect errors within the data packet. The error detection code for commonly used in wireless communication can be a checksum data value of the data packet, a parity check data value or a cyclic redundant check (or CRC) data value. A stop bit 26 is set up at the end of the data frame to indicate the end of data frame.

Referring to FIG. 3, if the user enters four pieces of data by the wireless input apparatus 11, four data frames A, B, C and D will be transmitted from the transmitting end (wireless input apparatus 11) to the receiving end (wireless signal receiving apparatus 12). In the middle of data transmission process, however, if noise or other external interference is generated, it is probable that the receiving end can not receive data frame C. Though the error detection technique as described above can be applied by the receiving end to detect the error within the data packet during the data reception process, it only can detect the error within the data packet but can not detect the data loss or data corruption. As a result, the user is no way of perceiving the data loss problems encountered by the wireless data transmission process.

There is an inclination to provide a remedy for the data loss problems which is occurred during the wireless communication process.

### SUMMARY OF THE INVENTION

A first object of the present invention is to provide a method for data loss detection in a wireless communication process.

A second object of the present invention is to provide a method for data loss recovery in a wireless communication process.

A third object of the present invention is to provide a wireless communication system which is operable to detect the data loss generated during a wireless communication process.

A fourth object of the present invention is to provide a wireless communication system which is operable to recover the lost data taken place during a wireless communication process.

A fifth object of the present invention is to provide a data frame format to be used in a wireless communication system for detecting whether the data frame is lost during a wireless communication process.

To attain the first and the second object of the present invention, a method for data loss detection and recovery in a wireless communication process is presented and comprises the steps of: receiving a wireless signal carrying a data frame by a wireless signal receiving apparatus, wherein the data frame includes a field containing a first data value representing a sequence number of the data frame, and the wireless signal receiving apparatus records a second data value representing a sequence number next to that of the last data frame being received by the wireless signal receiving apparatus; comparing the first data value with the second data value to determine whether the data frame is lost during the wireless communication process; if the first data value is different from the second data value, either generating an alarm signal by the wireless signal receiving apparatus or transmitting a request signal to a wireless input apparatus to request the wireless input apparatus to retransmit the lost data frame to the wireless signal receiving apparatus; increasing the second data value being recorded in the wireless signal receiving apparatus by one; and decoding a data packet contained within the data frame into a series of output data signals, and transmitting the output data signals by the wireless signal receiving apparatus to a host.

The third object of the present invention can be achieved by a wireless communication system comprising a wireless input apparatus which is operable to receive an input data signal and encode the input data signal into a data frame for transmission by a wireless signal, wherein the data frame includes a field containing a first data value representing a sequence number of the data frame; a channel for transmitting the wireless signal; and a wireless signal receiving apparatus which is operable to receive the wireless signal from the channel and records a second data value representing a sequence number next to that of the last data frame being received by the wireless signal receiving apparatus, wherein the wireless signal receiving apparatus compares the first data value with the second data value to determine whether the data frame is lost, and generates an alarm signal if the first data value is different from the second data value.

The wireless input apparatus includes an input interface for allowing a user to enter the input data signal; an input buffer, for example, a FIFO buffer for storing the input data signal therein; a microcontroller having an encoder for encoding the input data signal into a data frame; a wireless communication transmitting module for transmitting the wireless signal to the wireless signal receiving apparatus through the channel; and a memory, for example, a FIFO memory for recording the data frame transmitted by the wireless input apparatus.

The wireless signal receiving apparatus includes a wireless communication receiving module for receiving the wireless signal from the channel; a microcontroller having a decoder for decoding a data packet contained within the data frame into a series of output data signals; a register for storing the second data value therein; and an alarm signal generator such as a buzzer for generating the alarm signal.

The aforementioned wireless communication system further includes a host, for example, a personal computer which is connected with the wireless signal receiving apparatus by a cable for receiving and processing the output data signals.

The fourth object of the present invention can be fulfilled by a wireless communication system comprising a wireless input apparatus which is operable to receive an input data signal and encode the input data signal into a data frame for transmission by a wireless signal, wherein the data frame includes a field containing a first data value representing a sequence number of the data frame; a channel for transmitting the wireless signal; and a wireless signal receiving apparatus which is operable to receive the wireless signal from the channel and record a second data value representing a sequence number next to that of the last data frame being received by the wireless signal receiving apparatus, wherein the wireless signal receiving apparatus compares the first data value with the second data value to determine whether the data frame is lost, and generates a request signal to the wireless input apparatus to request the wireless input apparatus to retransmit the data frame if the first data value is different from the second data value.

The fifth object of the present invention is direct to a data frame format to be used in a wireless communication system. The data frame is constructed by at least a data packet and a data sequence ID field containing a data value representing a sequence number of the data frame which enables the wireless communication system to detect whether the data frame is lost during a wireless communication process.

Furthermore, the data frame includes an error detection code based on the data values within the data packet which is to be analyzed to detect errors within the data packet. The error detection code can be a checksum data value of the data packet, a parity check data value or a cyclic redundant check (or CRC) data value.

Now the foregoing and other features and advantages of the present invention will be more clearly understood through the following descriptions with reference to the accompanying drawings, in which:

### BRIEF DESCRIPTION OF THE DRAWINGS

FIG. 1(a) is a systematic block diagram showing a unidirectional wireless communication system;

FIG. 1(b) is a systematic block diagram showing a bi-directional wireless communication system;

FIG. 2 schematically shows the data frame format for use in the conventional wireless communication system.

FIG. 3 schematically shows the data transmission/reception process in a conventional wireless communication system.

FIG. 4 schematically shows the data frame format for use in the wireless communication system according to the present invention;

FIG. 5 schematically shows the data transmission/reception process in a wireless communication system of the present invention;

FIGS. 6(a) and 6(b) respectively show the control flow of the unidirectional wireless data communication process at the transmitting end and at the receiving end; and

FIGS. 7(a) and 7(b) respectively show the control flow of the bidirectional wireless data communication process at the transmitting end and at the receiving end.

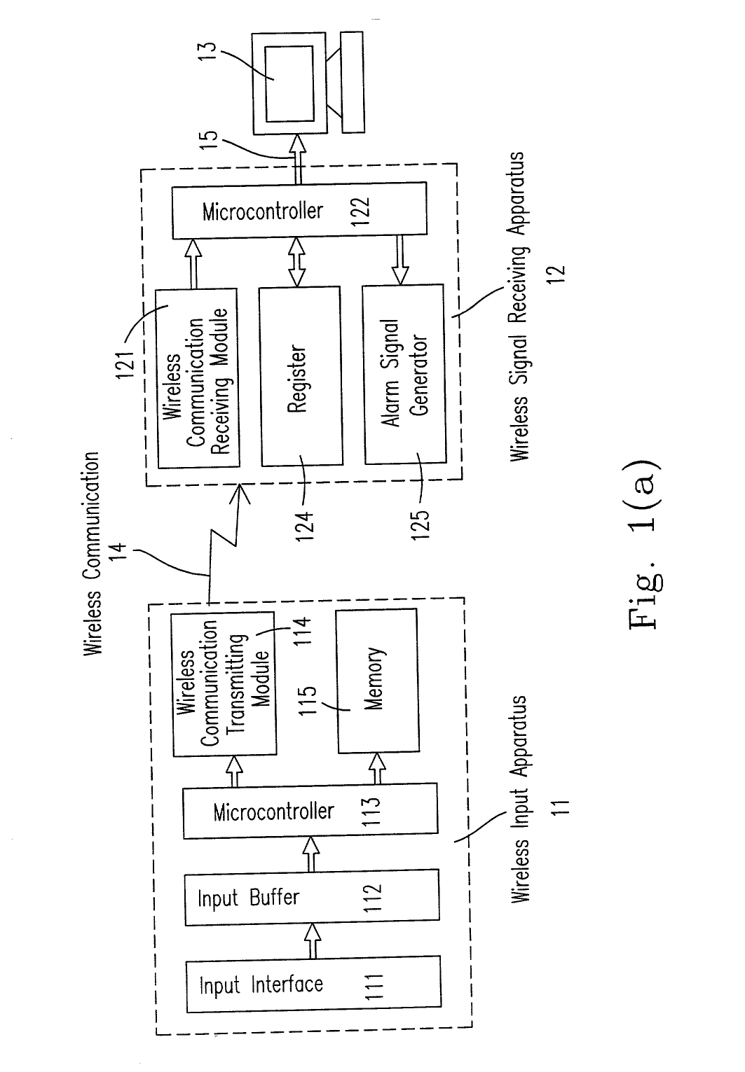

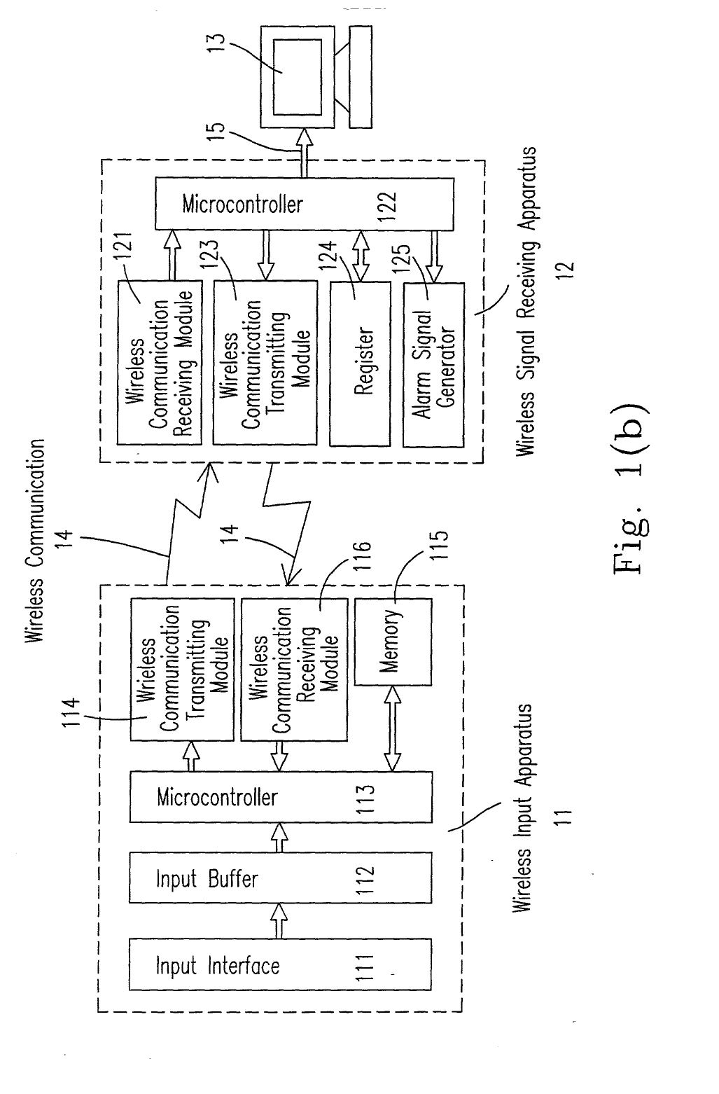

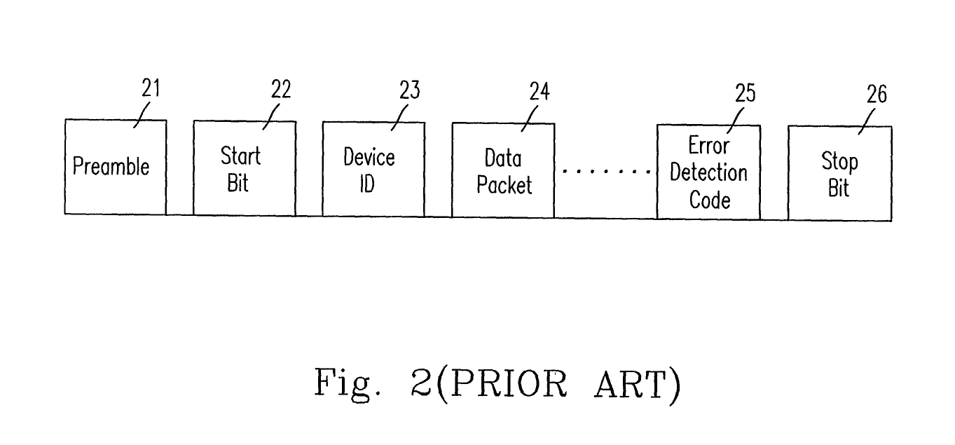

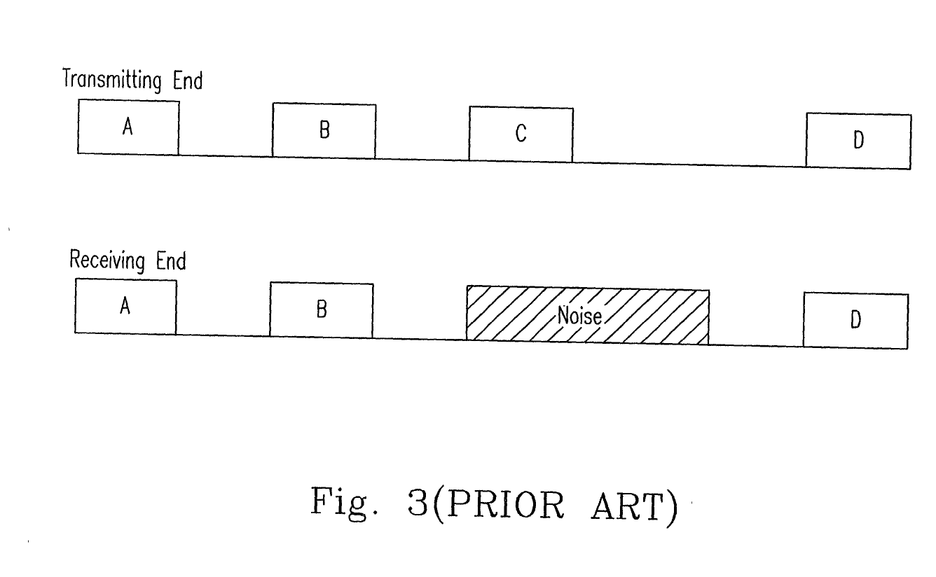

### DETAILED DESCRIPTION OF THE PREFERRED EMBODIMENT

The present invention is based on the cognition that by incorporating a data sequence identification (ID) field into the data frame which contains a data value representing the sequence number of the data frame, and transmitting the data frame by a wireless signal to a wireless signal receiving apparatus. The wireless signal receiving apparatus is able to compare the sequence number contained in the data sequence identification field of the data frame and the recorded sequence number which represents the sequence number of the data frame the wireless signal receiving apparatus should receive at this time. In this manner, the wireless signal receiving apparatus can determine whether or not a data loss problem is occurred to the wireless communication process, and identify which data frame is lost during the wireless communication process.

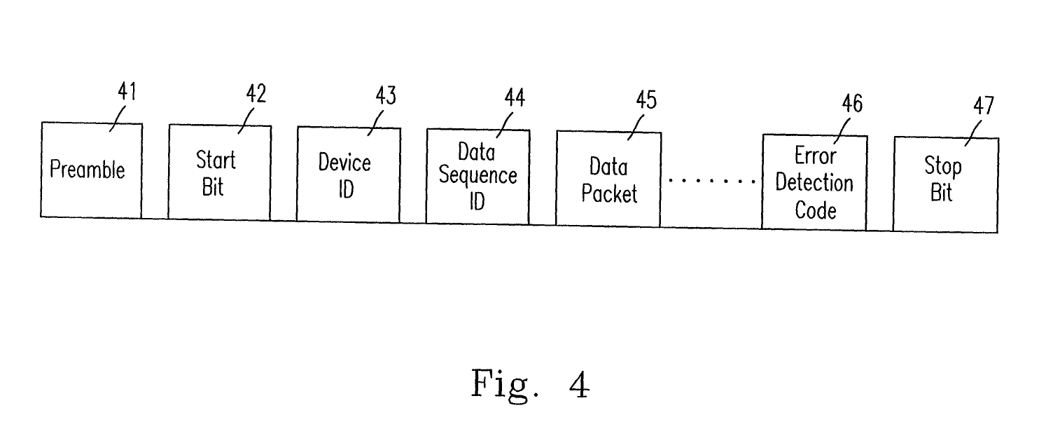

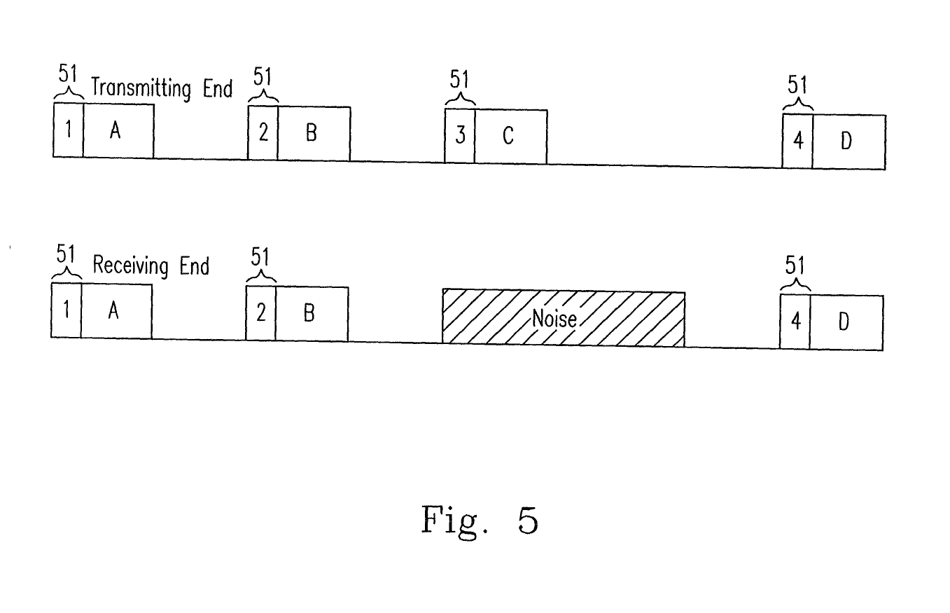

FIG. 4 schematically shows the data frame format for use in the wireless communication system according to the present invention. The exact data frame format for use in a wireless communication process is defined by the protocol using in the wireless communication system, and the data frame format as shown in FIG. 4 is taken as a way of example only, but is not intended to be limited to the precise form disclosed. For the purpose of preventing the receiving end from getting ignorant of the data loss problem under the influence of noise or other external interferences, a data sequence ID field 44 is incorporated into the data frame to identify the sequence number of the current data frame. As shown in FIG. 4, the data frame is constituted by an initial preamble 41, a start bit 42, a device ID field 43, a data sequence ID field 44 indicative of the sequence number of current data frame, one or more data packets 45 followed by the data sequence ID 44, error detection codes 46 each of which is appended to the individual data packet 45, and a stop bit 47 set up at the end of the data frame. The data value contained in the data sequence ID field 44 represents the sequence number of the current data frame. When the transmitting end is transmitting data, data frames will be transmitted sequentially in accordance with the sequence number contain in the data sequence ID field 44 of the data frame, and the transmitted data frame will be recorded in a memory (for example, a first-in first-out (FIFO) memory) of the transmitting end. As indicated in FIG. 5, data frames A, B, C and D are successive data frames, and each includes a data sequence ID field 51 containing a data value representing the sequence number of the data frame. It can be seen that the sequence number of data frame A is 1, the sequence number of data frame B is 2, the sequence number of data frame C is 3 and the sequence number of data frame D is 4. The transmitting end transmits these data frames sequentially in accordance with the sequence number of the data frame. If noise or external interference is generated in the middle of wireless data transmission process to cause the receiving end to receive data frames A, B and D but fail to receive data frame D, data loss problems is occurred. However, when the receiving end is receiving data, the sequence number of the received data frame will be compared with the content of the register which contains the sequence number of the data frame next to that of the last data frame being received by the receiving end. If the result of comparison reveals that the received data frame is not the succession of the last frame that the receiving end has received, it is no doubt that data loss problem is occurred. The wireless signal receiving apparatus will drive the alarm signal generator, for example, a buzzer, to generate alarm signals to remind the user of the data loss problem, or send a retransmission request signal to request the transmitting end to retransmit the transmitted data from where the data loss is occurred.

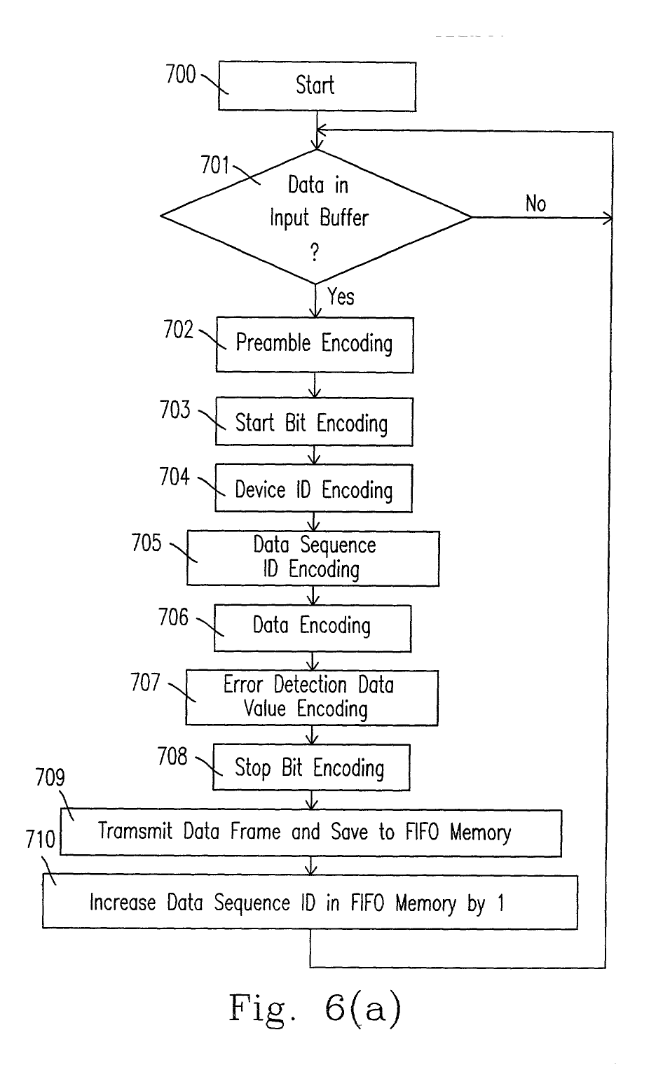

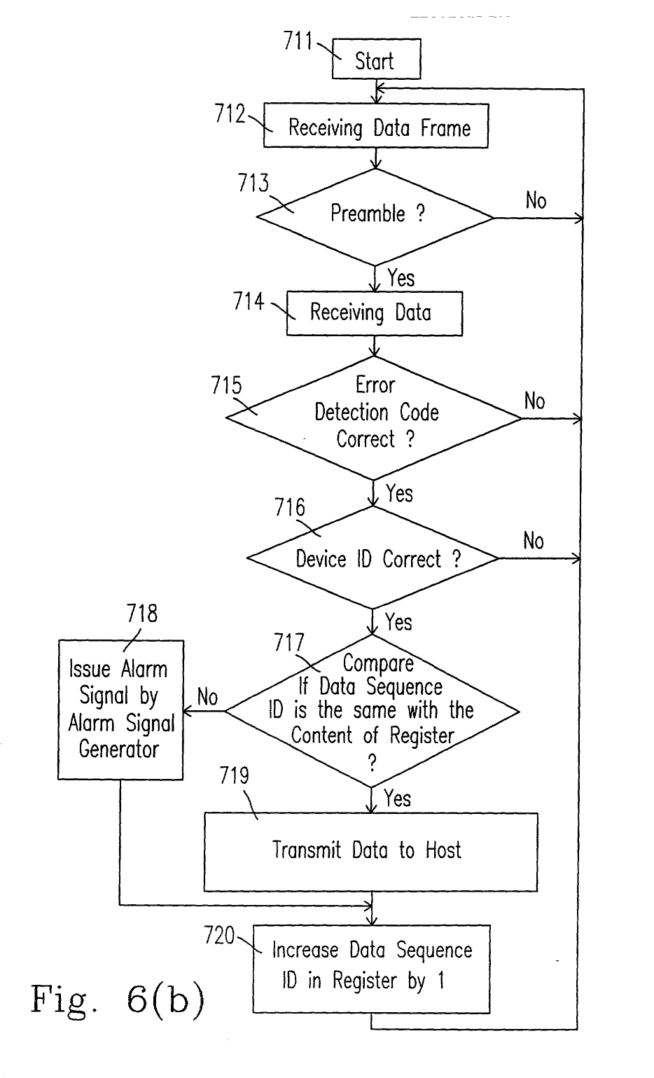

FIGS. 6(a) and 6(b) respectively show the control flow of the unidirectional wireless data communication process at the transmitting end and at the receiving end. In accordance with a first preferred embodiment of the present invention, the unidirectional wireless data transmission process of the transmitting end starts at the step 700 of FIG. 6(a). At decision 701, the input buffer of the transmitting end will be checked if there contains any data to determine whether the user has entered input data by the wireless input apparatus or not. If no data is contained in the input buffer, it indicates that the user has not entered input data by the wireless input apparatus, and the wireless input apparatus will be of no operation. If there contains data in the input buffer, the input data signal which is entered by the user will be encoded by the microcontroller of the wireless input apparatus to form a data frame. The data encoding process is started at step 702 by first establishing a preamble which represents the initial of the data frame. At step 703, a start bit is attached to the preamble. At step 704, a device ID is attached to the start bit. At step 705, a data sequence ID is attached to the device ID. At step 706, the input data signals are encoded into a data packet and attached to the data sequence ID. In order to detect the errors within the data packet, an error detection code, for example, the checksum data value of the data packet, a parity check data value or a CRC data value, is followed by the data packet at step 707. At step 708, a stop bit is set up at the end of the data frame to indicate the end of data frame, and thus a data frame is formed. The wireless communication transmitting module of the transmitting end will transmit the data frame by wireless signal, and the transmitted data frame will be saved in a FIFO memory of the wireless input apparatus at step 709. The FIFO memory will also record the data sequence ID of the transmitted data frame. When the data frame has been transmitted by wireless signal, the data sequence ID recorded in the FIFO memory will be increased by one, so that the sequence number of the lost data frames can be rapidly found out if the receiving end fails to receives these data frames.

Referring to FIG. 6(b), the data reception process of the receiving end is started at step 711. After the wireless signal receiving apparatus has received the data frame at step 712, it will be checked if preamble is received at step 713. If no preamble received, the data frame will be discarded and the receiving end keeps on waiting the next data frame. If preamble received, the data reception and decoding process will be put through at step 714. At decision 715, the error detection code will be analyzed to detect errors within the data packet. If errors within the data packet are detected, because the wireless communication system is unidirectional, the received data frame can not be recovered by the retransmission of the data frame from the transmitting end, and the received data frame will be discarded. If no error is contained within the data packet, at step 716 the device ID will be checked if the device ID of the transmitting end is correct. If not, the received data frame will be discarded. If yes, at step 717 the data value contained in the data sequence ID will be compared with the content of the register of the receiving end to determine whether the received data frame is the succession of the last data frame that the receiving end has received. If the data value contained in the data sequence ID is different from the content of the register, the alarm signal generator of the receiving end generates alarm signals to remind the user of the data loss problems at step 718. If the data value contained in the data sequence ID is identical to the content of the register, the data packet will be decoded into original data signals and transmitted to the host at step 719. At step 720, the data value content of the register representing the sequence number of data frame that the receiving end should receive in the next data reception process is increased by one, and thus the data reception process of the receiving end is finished.

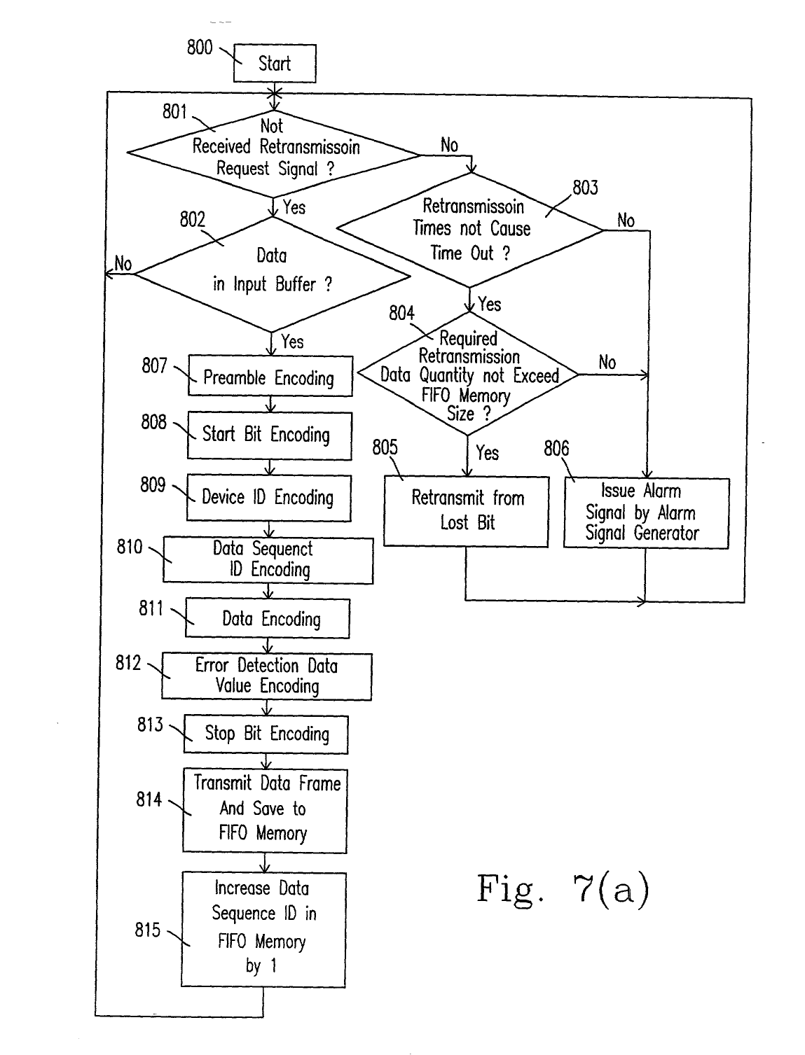

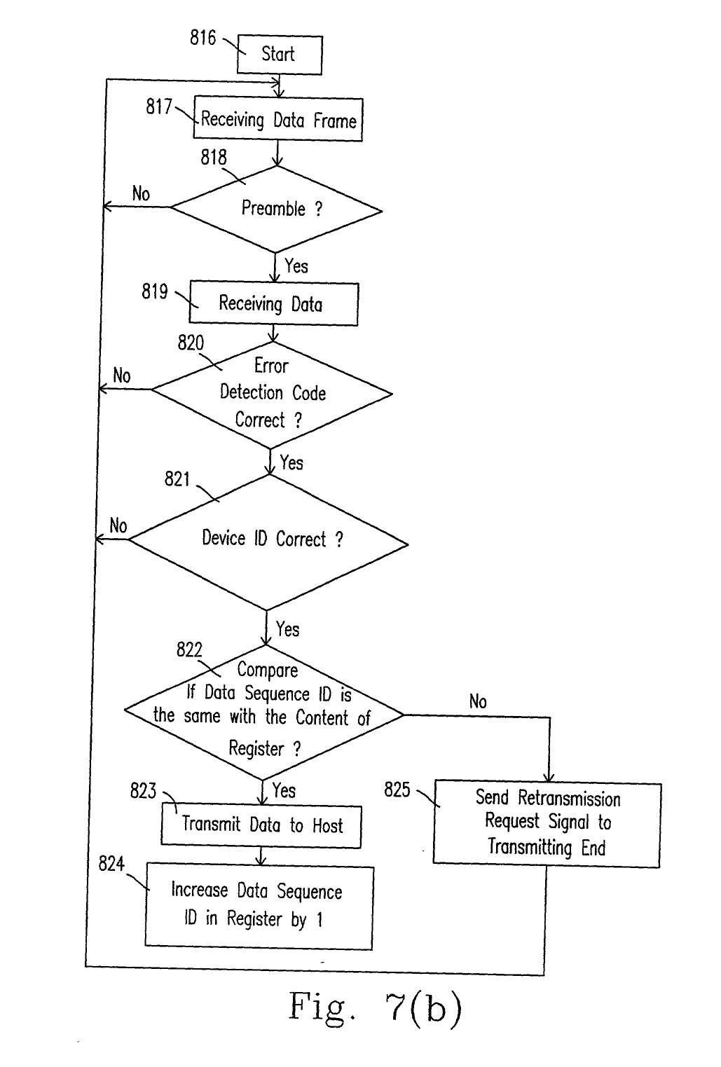

FIGS. 7(a) and 7(b) respectively show the control flow of the bi-directional wireless data communication process at the transmitting end and at the receiving end. Comparing the control flows of the wireless communication process of FIGS. 7(a) and 7(b) with FIGS. 6(a) and 6(b), it can be easily understood because the bi-directional wireless communication system of FIGS. 7(a) and 7(b) can get into bi-directional wireless communication between the transmitting end and the receiving end, the receiving end can request the transmitting end to retransmit the lost data when the data loss problem is occurred to the receiving end during the data transmission process. The data reception process at the receiving end of the bi-directional wireless communication system is started at step 800. At step 801, if the transmitting end receives the retransmission request signal from the receiving end, the data retransmission process will be put in progress. At decision 803, the number of times of retransmission requests will be checked if it exceeds the default time-out value preset by the protocol using in the wireless communication system. If yes, the microcontroller of the transmitting end will send a control signal to drive the alarm signal generator of the transmitting end to generate alarm signals instead of retransmitting the lost data at step 806. If not, the data quantity that is requested to be retransmitted will be checked if it surpasses the storage capacity of the FIFO memory. If yes, the data retransmission request will be ignored and the microcontroller of the transmitting end will send a control signal to drive the alarm signal generator of the transmitting end to generate alarm signals at step 806. If not, at step 805 the lost data is transmitted from the FIFO memory where the lost bits resides to the receiving end. As to steps 802 to 815, they are similar to the steps of 701 to 710 of FIG. 6(a), and we are not intended to give further details herein.

In FIG. 7(b), the data reception of the receiving end is started at step 816. Steps 816 to 824 are similar to the steps 711 to 720 of FIG. 6(b), wherein the only difference is that at the decision 822 of FIG. 7(b), if the data loss is detected, the receiving end will send a retransmission request signal to the transmitting end to request the transmitting end to retransmit lost data at step 825, instead of generating alarm signals by the alarm signal generator to remind the user of data loss problems at step 718 of FIG. 6(b). As the receiving end has transmitted the retransmission request signal to the transmitting end, the transmitting end will start the data retransmission process in response to the retransmission request signal as discussed in steps 803 to 806. Therefore the lost data can be recovered by the transmitting end.

It is apparent from the above discussions that the most conspicuous feature of the data loss detection and recovery technique in a wireless communication system of the present invention is to incorporate a data sequence ID field into the data frame, which contains the sequence number of the data frame, and the wireless signal receiving apparatus of the wireless communication system keeps track on the sequence number of the received data frames. Upon receipt of the wireless signal carrying the data frame, the wireless signal receiving apparatus compares the data value contained in the data sequence ID field of the received data frame with the record of the sequence number of the data frame that should be received at this time. Even noise or other external interference is intervened in the wireless data transmission process and results in a data loss, the wireless signal can automatically and promptly detect the data loss according to the result of comparison between the sequence number of the received data frame and the recorded sequence number of data frame that the should be received at this time. By introducing the present invention into the general wireless communication architecture, the unawareness of the data loss problem in the wireless communication process can be thoroughly reformed, and the communication quality can be advanced greatly.

Those of skill in the art will recognize that these and other modifications can be made within the spirit and scope of the present invention as further defined in the appended claims.

What is claim is:

1. A method for a data loss detection in a wireless communication process comprising the steps of:
(a) receiving a wireless signal carrying a data frame by a wireless signal receiving apparatus, wherein said data frame includes a field containing a first data value representing a sequence number of said data frame, and said wireless signal receiving apparatus records a second data value representing a sequence number next to that of the last data frame being received by said wireless signal receiving apparatus; and
(b) comparing whether said first data value is identical to said second data value, so as to determine whether said data frame is lost during said wireless communication process.

2. The method of claim 1 further comprising the steps of:
(c) if said first data value is different from said second data value, generating an alarm signal by said wireless signal receiving apparatus;
(d) increasing said second data value recorded in said wireless signal receiving apparatus by one; and
(e) decoding a data packet contained in said data frame into a series of output data signals, and transmitting said output data signals by said wireless signal receiving apparatus to a host.

3. The method of claim 2 wherein said step (c) further comprises the steps of:
(c1) if said first data value is different from said second data value, transmitting a request signal to a wireless input apparatus to request said wireless input apparatus to retransmit said data frame to said wireless signal receiving apparatus.

4. A method for a data loss recovery in a wireless communication process comprising the steps of:
(a) receiving a wireless signal carrying a data frame by a wireless signal receiving apparatus, wherein said data frame includes a field containing a first data value representing a sequence number of said data frame, and said wireless signal receiving apparatus records a second data value representing a sequence number next to that of the last data frame being received by said wireless signal receiving apparatus;
(b) comparing whether said first data value is identical to said second data value, so as to determine whether said data frame is lost during said wireless communication process; and
(c) if said first data value is different from said second data value, transmitting a request signal to a wireless input apparatus to request said wireless input apparatus to retransmit said data frame to said wireless signal receiving apparatus.

5. The method of claim 4 further comprising the steps of:
(d) increasing said second data value recorded in said wireless signal receiving apparatus by one; and
(e) decoding a data packet contained in said data frame into a series of output data signals, and transmitting said output data signals by said wireless signal receiving apparatus to a host.

6. A wireless communication system comprising:
a wireless input apparatus which is operable to receive an input data signal and encode said input data signal into a data frame for transmission by a wireless signal, wherein said data frame includes a field containing a first data value representing a sequence number of said data frame;
a channel for transmitting said wireless signal; and
a wireless signal receiving apparatus which is operable to receive said wireless signal from said channel and record a second data value representing a sequence number next to that of the last data frame being received by said wireless signal receiving apparatus, wherein said wireless signal receiving apparatus compares said first data value with said second data value to determine whether said data frame is lost, and generates an alarm signal if said first data value is different from said second data value.

7. The system of claim 6 wherein said wireless input apparatus includes an input interface for allowing a user to enter said input data signal and an input buffer for storing said input data signal therein.

8. The system of claim 7 wherein said input buffer comprises a first-in first-out buffer.

9. The system of claim 6 wherein said wireless input apparatus further includes a microcontroller having an encoder for encoding said input data signal into said data frame.

10. The system of claim 6 wherein said wireless input apparatus further includes a wireless communication transmitting module for transmitting said wireless signal to said wireless signal receiving apparatus through said channel.

11. The system of claim 6 wherein said wireless input apparatus further includes a memory for recording said data frame transmitted by said wireless input apparatus.

12. The system of claim 11 wherein said memory is a first-in first-out memory.

13. The system of claim 6 wherein said wireless signal receiving apparatus includes a wireless communication receiving module for receiving said wireless signal from said channel.

14. The system of claim 6 wherein said wireless signal receiving apparatus further includes a microcontroller having a decoder for decoding a data packet contained in said data frame into a series of output data signals.

15. The system of claim 6 wherein said wireless signal receiving apparatus further includes a register for storing said second data value therein.

16. The system of claim 6 wherein said wireless signal receiving apparatus further includes an alarm signal generator for generating said alarm signal.

17. The system of claim 16 wherein said alarm signal generator is a buzzer.

18. The system of claim 6 further comprising a host which is connected with said wireless signal receiving apparatus by a cable for receiving and processing said output data signals.

19. The system of claim 18 wherein said host is a personal computer.

20. A wireless communication system comprising:
a wireless input apparatus which is operable to receive an input data signal and encode said input data signal into a data frame for transmission by a wireless signal, wherein said data frame includes a field containing a first data value representing a sequence number of said data frame;
a channel for transmitting said wireless signal; and
a wireless signal receiving apparatus which is operable to receive said wireless signal from said channel and record a second data value representing a sequence number next to that of the last data frame being received by said wireless signal receiving apparatus, wherein said wireless signal receiving apparatus compares said first data value with said second data value to determine whether said data frame is lost, and generates a request signal to said wireless input apparatus to request said wireless input apparatus to retransmit said data frame if said first data value is different from said second data value.

21. The system of claim 20 wherein said wireless input apparatus includes an input interface for allowing a user to enter said input data signal and an input buffer for storing said input data signal therein.

22. The system of claim 21 wherein said input buffer comprises a first-in first-out buffer.

23. The system of claim 20 wherein said wireless input apparatus further includes a microcontroller having an encoder for encoding said input data signal into said data frame.

24. The system of claim 20 wherein said wireless input apparatus further includes a wireless communication transmitting module for transmitting said wireless signal carrying said data frame to said wireless signal receiving apparatus through said channel, and a wireless communication receiving module for receiving said request signal.

25. The system of claim 20 wherein said wireless input apparatus further includes a memory for recording said data frame transmitted by said wireless input apparatus.

26. The system of claim 25 wherein said memory is a first-in first-out memory.

27. The system of claim 20 wherein said wireless signal receiving apparatus includes a wireless communication receiving module for receiving said wireless signal carrying said data frame from said channel, and a wireless communication transmitting end for transmitting said request signal.

28. The system of claim 20 wherein said wireless signal receiving apparatus further includes a microcontroller having a decoder for decoding a data packet contained in said data frame into a series of output data signals.

29. The system of claim 20 wherein said wireless signal receiving apparatus further includes a register for storing said second data value therein.

30. The system of claim 20 wherein said wireless signal receiving apparatus further includes an alarm signal generator for generating said alarm signal.

31. The system of claim 30 wherein said alarm signal generator is a buzzer.

32. The system of claim 20 further comprising a host which is connected with said wireless signal receiving apparatus by a communication cable for receiving and processing said output data signals.

33. The system of claim 32 wherein said host is a personal computer.

34. A data frame format to be used in a wireless communication system, wherein said data frame at least includes a data packet and a field containing a data value representing a sequence number of said data frame which enables said wireless communication system to detect whether said data frame is lost during a wireless communication process.

35. The data frame format of claim 34 wherein said data frame further includes a field containing an error detection code based on the data values within in said data packet which is to be analyzed to detect errors within said data packet.

36. The data frame format of claim 35 wherein said error detection code contains a checksum data value.

37. The data frame format of claim 35 wherein said error detection code contains a parity check data value.

38. The data frame format of claim 35 wherein said error detection code contains a cyclic redundancy check data value.
